(19) United States
(12) Patent Application Publication
(10) Pub. No.: US 2016/0162175 A1
(43) Pub. Date: Jun. 9, 2016

(54) ELECTRONIC APPARATUS

(71) Applicant: KABUSHIKI KAISHA TOSHIBA, Tokyo (JP)

(72) Inventors: Yoshikazu Terunuma, Ome Tokyo (JP); Junichi Nagata, Tsurugashima Saitama (JP)

(21) Appl. No.: 14/793,589

(22) Filed: Jul. 7, 2015

Related U.S. Application Data
(60) Provisional application No. 62/088,458, filed on Dec. 5, 2014.

(51) Int. Cl. G06F 3/0488; G06F 3/041

(52) U.S. Cl. CPC G06F 3/04883; G06F 3/041

(57) ABSTRACT

According to one embodiment, circuitry receives data relating to strokes including vertical lines and horizontal lines, wherein cells substantially surrounded by the vertical lines and horizontal lines are formed, and a table formed by the cells includes m rows and n columns wherein m and n are integers of one or greater, recognizes the strokes as an object of a table when m is greater than or equal to a first value and n is greater than or equal to a second value, and recognizes the strokes as an object other than the table when m is less than the first value and n is less than the second value.

### CROSS-REFERENCE TO RELATED APPLICATIONS

This application claims the benefit of U.S. Provisional Application No. 62/088,458, filed Dec. 5, 2014, the entire contents of which are incorporated herein by reference.

### FIELD

Embodiments described herein relate generally to a handwriting input technique.

### BACKGROUND

In conventional electronic apparatuses, characters or commands are input with a keyboard, a mouse, etc. Recently, electronic apparatuses with a touch panel such as tablets and smart phones have been developed to facilitate the input. Such apparatuses allow characters, figures, etc., to be written by hand on the touch panel with a stylus.

A document written by hand is stored not as image data but as stroke data indicating the coordinates of sampling points of each of the strokes constituting a character and the order of strokes (order in which the strokes are handwritten). However, a digital object obtained by digitizing the handwritten document is sometimes stored as well as the stroke data. The digital object includes text data obtained by performing character recognition of the handwritten document and table data obtained by shaping a handwritten table. Some characters in the handwritten document are difficult to distinguish from a table, and sometimes, a table is erroneously recognized as a character, or a character is erroneously recognized as a table.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an outer appearance of an electronic apparatus according to an embodiment.

FIG. 2 shows an example of a cooperative operation between the electronic apparatus and external devices.

FIG. 3 shows an example of a document handwritten on a touch screen display of the electronic apparatus.

FIG. 4 shows an example of stroke data corresponding to the handwritten document in FIG. 3.

FIG. 5 is a block diagram showing an example of a system configuration of the electronic apparatus.

FIG. 6 is a block diagram showing an example of a function configuration of a digital notebook application program executed by the electronic apparatus.

FIG. 7 is a flowchart showing an example of handwritten table recognition processing executed by the electronic apparatus.

FIG. 8A shows an example of a stroke data group recognized as a character.

FIG. 8B shows an example of a stroke data group recognized as a table.

### DETAILED DESCRIPTION

Various embodiments will be described hereinafter with reference to the accompanying drawings. In general, according to one embodiment, an electronic apparatus includes circuitry. The circuitry is configured to receive data relating to a plurality of strokes comprising a plurality of vertical lines and a plurality of horizontal lines, wherein a plurality of cells substantially surrounded by the plurality of vertical lines and the plurality of horizontal lines are formed, and a table formed by the plurality of cells comprises m rows and n columns wherein m and n are integers of one or greater; recognize the plurality of strokes as an object of a table when m is greater than or equal to a first value and n is greater than or equal to a second value; and recognize the plurality of strokes as an object other than the table when m is less than the first value and n is less than the second value.

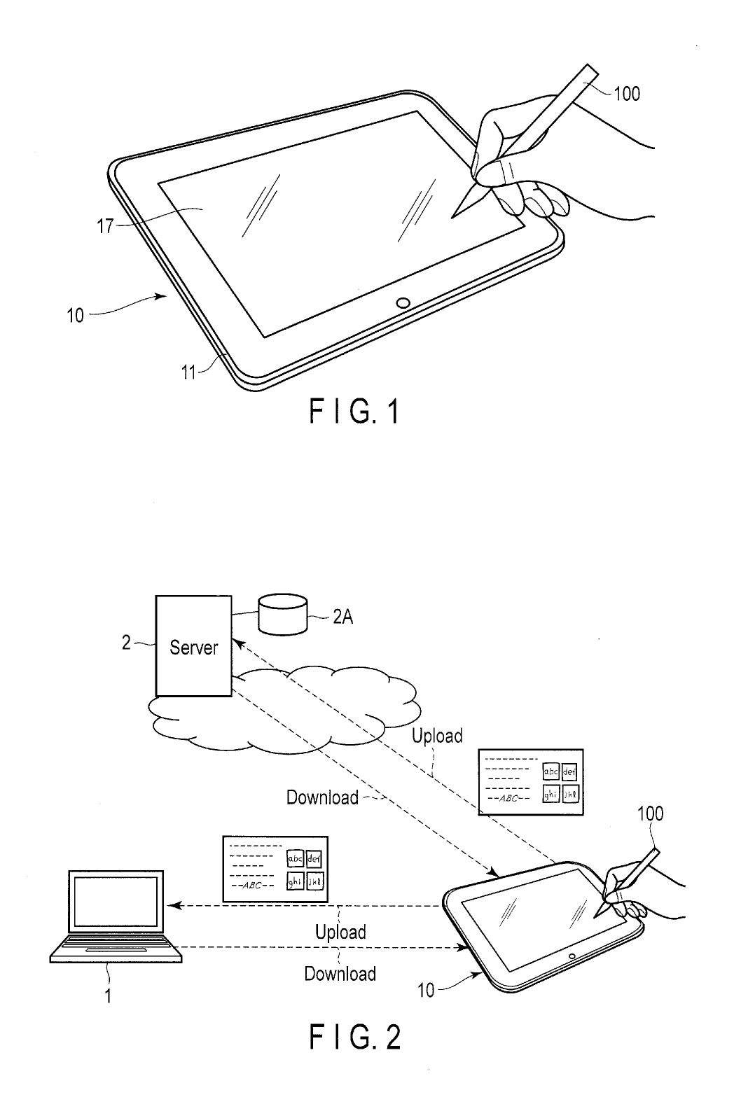

FIG. 1 is a perspective view showing an outer appearance of an electronic apparatus according to an embodiment. The electronic apparatus is, for example, a stylus-based portable electronic apparatus in which handwriting input is possible with a stylus or a finger. The electronic apparatus can be realized as a tablet, a notebook computer, a smart phone, a PDA, etc. A case where the electronic apparatus is realized as a tablet 10 is hereinafter assumed. The tablet 10 is a portable electronic apparatus also called a slate computer, and includes a main body 11 including a thin box housing and a touch screen display 17 attached to the upper surface of the main body 11 in piles.

A flat panel display and a sensor are mounted in the touch screen display 17. The sensor is configured to detect a contact position of the stylus or finger on a screen of the flat panel display. The flat panel display may be, for example, a liquid crystal display (LCD). As the sensor, for example, a capacitive touch panel or an electromagnetic induction digitizer can be used. Although the sensor is not limited to them, both types of sensor, the digitizer and touch panel, are mounted in the touch screen display 17.

The digitizer is arranged, for example, below the screen of the flat panel display. The touch panel is arranged, for example, on the screen of the flat panel display. Thus, the touch screen display 17 can detect not only a touch operation on the screen by use of the finger but that on the screen by use of a stylus 100. The stylus 100 can be, for example, a digitizer stylus (electromagnetic induction stylus), an active stylus, a passive stylus, etc.

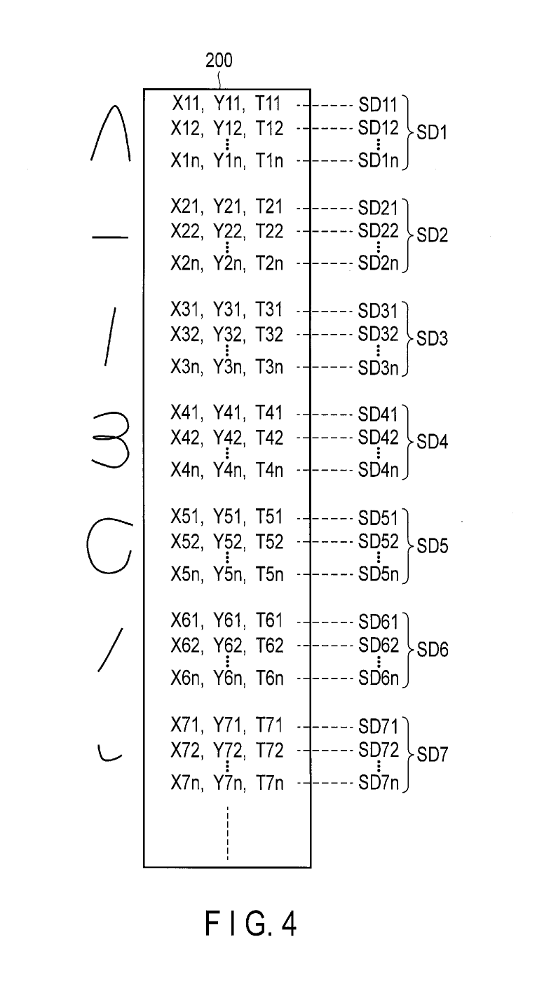

The user can perform handwriting input operation on the touch screen display 17 using an external object (stylus 100 or finger). While the handwriting input operation is performed, a locus of motion of the external object (stylus 100 or finger) on the screen, that is, a stroke is drawn in real time. One stroke corresponds to the locus of motion of the external object while the external object is in contact with the screen. A set of a number of strokes corresponding to a handwritten character, a handwritten table, a handwritten figure or the like constitutes a handwritten document. In the present embodiment, the handwritten document is stored in a storage medium not as bitmap image data but as stroke data indicating a coordinate string of a locus of each stroke, and an order relationship between strokes. The stroke data will be described in detail with reference to FIG. 4. The tablet 10 can display, on the screen, not only a real-time handwritten document but also a handwritten document corresponding to arbitrary existing stroke data read from the storage medium, that is, a plurality of strokes indicated by the stroke data.

The tablet 10 has an editing function. The editing function includes copying an object to a clipboard, pasting an object from the clipboard (including exporting an object to another application), importing an image, etc. This allows an arbitrary stroke, handwritten character or the like in a displayed handwritten document to be deleted, copied, cut or moved.

Furthermore, the tablet 10 also has a recognition function for recognizing the handwritten document. The recognition function includes a character recognition function, a table recognition function and a figure recognition function. Since the figure recognition function is not related to the embodiment, the detailed description thereof will be omitted. The recognition function allows a digital object corresponding to a handwritten object (handwritten character, handwritten table and handwritten figure) to be obtained. The digital object may be output as formatted digital data. The formatted digital data is a data file including a file format which can be handled by another application program such as a document integration application. The digital character object is text data including a character code. The digital table object is utilized by a spreadsheet application program, a presentation application program, etc. The character recognition, table recognition, etc., may be performed at the time of pasting an object on a clipboard or exporting an object to another application.

FIG. 2 shows an example of a cooperative operation between the tablet 10 and external devices. The tablet 10 includes a wireless communication device such as a wireless LAN. The tablet 10 can execute wireless communication with a personal computer 1, and execute communication with a server 2 on the Internet. The personal computer 1 includes a storage device such as a hard disk drive (HDD). The tablet 10 can transmit stroke data items to the personal computer 1, and store them in the HDD of the personal computer 1 (upload). The tablet 10 can read at least one arbitrary stroke data item stored in the HDD of the personal computer 1 (download). The tablet 10 can display a stroke indicated by the read stroke data item on the screen of the touch screen display 17 of the tablet 10. Furthermore, the tablet 10 can transmit the stroke data items to the server 2 through a network, and store them in a storage device 2A of the server 2 (upload). The tablet 10 can read an arbitrary stroke data item stored in the storage device 2A of the server 2 (download). The tablet 10 can also display a stroke indicated by the read stroke data item on the screen of the touch screen display 17 of the tablet 10.

As shown above, in the present embodiment, a storage medium storing the stroke data of the handwritten document may be any of the storage devices in the tablet 10, personal computer 1 and server 2.

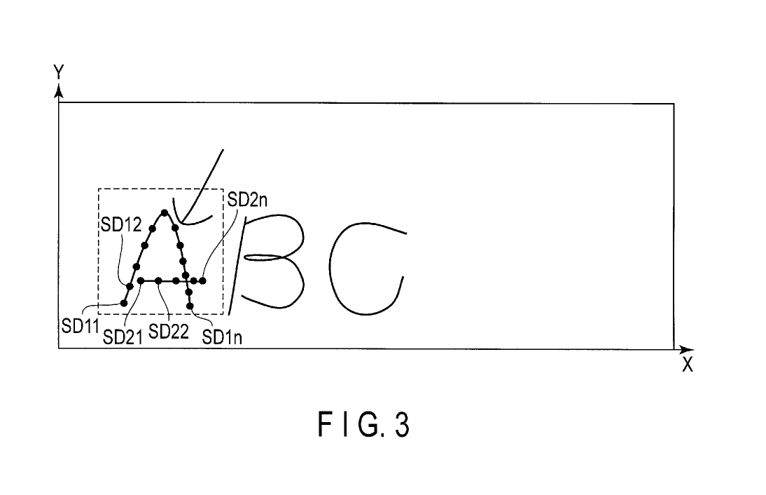

The relationship between a document handwritten by the user and the stroke data will be described with reference to FIGS. 3 and 4. FIG. 3 shows an example of a document (character string) handwritten on the touch screen display 17 using the stylus 100, etc.

In the handwritten document, another character or a figure is sometimes handwritten on a handwritten character or figure. A case where “A”, “B”, “C” of the character string “ABC” are handwritten in this order, and then, an arrow is handwritten very close to the handwritten character “A” is assumed in FIG. 3.

The handwritten character “A” is expressed by two strokes (“Λ”-shaped stroke and “−”-shaped stroke). The first handwritten “Λ”-shaped stroke is sampled in real time, for example, at regular time intervals, and then, coordinate strings SD11, SD12 . . . SD1n of the “Λ”-shaped stroke are obtained. Similarly, the “−”-shaped stroke handwritten next is also sampled in real time at regular time intervals, and then, coordinate strings SD21, SD22, . . . , SD2n of the “−”-shaped stroke are obtained.

The handwritten character “B” is expressed by two strokes. The handwritten character “C” is expressed by one stroke. The handwritten arrow is expressed by two strokes.

FIG. 4 shows stroke data 200 corresponding to the handwritten document in FIG. 3. The stroke data 200 includes stroke data items SD1, SD2 . . . SD7 corresponding to a plurality of strokes. The stroke data items SD1, SD2, . . . , SD7 are placed in time series in the stroke data 200 in the order of handwriting, that is, the order in which the plurality of strokes are handwritten.

In the stroke data 200, first two stroke data items SD1 and SD2 indicate two strokes of the handwritten character “A”. The third and fourth stroke data items SD3 and SD4 indicate two strokes constituting the handwritten character “B”. The fifth stroke data item SD5 indicates a stroke constituting the handwritten character “C”. The sixth and seventh stroke data items SD6 and SD7 indicate two strokes constituting the handwritten arrow.

Each stroke data item includes a plurality of coordinates each corresponding to a plurality of points on one stroke. In each stroke data item, the plurality of coordinates are placed in time series in the order in which the strokes are written. For example, regarding the handwritten character “A”, the stroke data item SD1 includes a coordinate data series (time-series coordinates) corresponding to points on the “Λ”-shaped stroke of the handwritten character “A”, that is, n coordinate data items SD11, SD12, . . . , SD1n. The stroke data item SD2 includes a coordinate data series corresponding to points on the “−”-shaped stroke of the handwritten character “A”, that is, n coordinate data items SD21, SD22, . . . , SD2n. If the strokes are sampled at regular time intervals, the number of coordinate data items differs for each stroke. Alternatively, if a fixed number of coordinate data items are to be obtained between strokes, a sampling interval varies in accordance with the lengths of the stroke.

Each coordinate data item indicates X coordinate and Y coordinate corresponding to a point on a corresponding stroke. For example, coordinate data item SD11 represents X coordinate X11 and Y coordinate Y11 at a start point of the “Λ”-shaped stroke. SD1n represents X coordinate X1n and Y coordinate Y1n at an end point of the “Λ”-shaped stroke.

Furthermore, each coordinate data item may include timestamp data T corresponding to a time when a point corresponding to the coordinate is handwritten. The handwritten time may be an absolute time (for example, year, month, day, hour, minute and second) or a relative time based on a specific time. For example, an absolute time (for example, year, month, day, hour, minute and second) when a stroke is first written may be added as timestamp data, and furthermore, a relative time indicating a difference from an absolute time may be added to each coordinate data item in the stroke data as timestamp data T. Although it is not shown in the figure, data (Z) indicating writing pressure may be added to each coordinate data item.

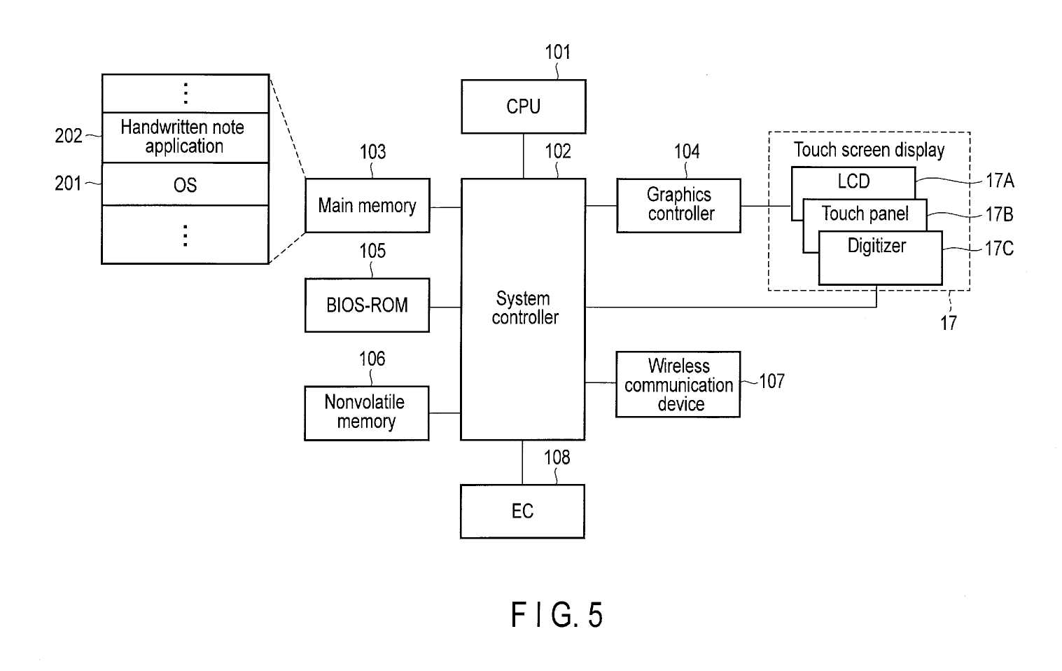

FIG. 5 shows an example of a system configuration of the tablet 10. The tablet 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor circuit configured to control an operation of various components in the tablet 10. The CPU 101 executes various computer programs loaded from the nonvolatile memory 106, which is a storage device, into the main memory 103. The programs include an operating system (OS) 201 and various application programs. The application programs include a digital notebook application program 202. The digital notebook application program 202 is a digital notebook application by which a note can be taken. The digital notebook application program 202 includes a function of inputting and displaying a handwritten document, that of editing the handwritten document, that of recognizing the handwritten document, etc. The CPU 101 executes a basic input/output system (BIOS) stored in the BIOS-ROM 105. The BIOS is a program for hardware control.

The system controller 102 is a device configured to connect between a local bus of the CPU 101 and various components. The system controller 102 includes a memory controller configured to perform access control on the main memory 103. Also, the system controller 102 includes a function of performing communication with the graphics controller 104 through a serial bus, etc., conforming to the PCIEXPRESS standard.

The graphics controller 104 is a graphics processing unit configured to control an LCD 17A used as a display monitor of the tablet 10. The graphics controller 104 includes a display control circuit. When the digital notebook application program 202 is executed, the graphics controller 104 can display a handwritten document including a plurality of strokes on the screen of the LCD 17A under control of the digital notebook application program 202. A display signal generated by the graphics controller 104 is transmitted to the LCD 17A. The LCD 17A displays a screen image based on the display signal. A touch panel 17B is arranged on the LCD 17A. The graphics controller 104 may be mounted in the CPU 101.

The wireless communication device 107 is a device configured to execute wireless communication such as wireless LAN or 3G mobile communication. The wireless communication device 107 includes a transmitter configured to transmit a signal and a receiver configured to receive a signal.

The EC 108 is a single-chip microcomputer including an embedded controller for power management. The EC 108 includes a function of powering on or off the tablet 10 in accordance with a power button operation by the user. The tablet 10 may include a peripheral interface for communicating with other input devices (mouse, keyboard, etc.).

Page inputting/editing functions of the digital notebook application program 202 will be hereinafter described.

The digital notebook application program 202 allows a stroke to be drawn with the stylus 100. The digital notebook application program 202 allows a stroke to be drawn by touch (finger gesture) or with a mouse in a touch input mode. The touch input mode is a mode in which a stroke is drawn with the finger or mouse. The user can turn on or off the touch input mode.

The digital notebook application program 202 can select an arbitrary handwritten object on a page (at least one stroke) or a whole page with a “selection (range selection)” tool. The digital notebook application program 202 supports copy, cut and paste functions of the selected handwritten object. The copy, cut and paste functions may be realized using a clipboard function of an OS. The clipboard is a temporary storage area for exchanging data between application programs. The digital notebook application program 202 can execute the following three types of copy.

(i) Copy: The digital notebook application program 202 copies (stores) the selected handwritten object to the clipboard as stroke data. An application to be pasted is the digital notebook application program 202.

(ii) Copy as image: The digital notebook application program 202 generates image data (for example, bitmap) corresponding to the selected handwritten object, and copies (stores) the image data to the clipboard. The application to be pasted is an application in which an image is handled.

(iii) Copy as document integration application data: The digital notebook application program 202 generates formatted data (digital object) corresponding to the selected handwritten object (handwritten character string, handwritten table, handwritten figure, etc.), and copies (stores) a digital object to the clipboard. The digital object is a data file including a file format which can be handled by other application programs. The application to be pasted is a presentation application, a word processing application, a spreadsheet application, etc., included in a document integration application program.

The processing of generating the digital object corresponding to the selected handwritten object is executed using character recognition, figure recognition and table recognition. In the character recognition, a text (character code) corresponding to a handwritten character string is generated. In the figure recognition, a digital figure object corresponding to a handwritten figure is generated. In the table recognition, a digital table object corresponding to a handwritten table is generated.

The digital notebook application program 202 also supports import/export functions. The digital notebook application program 202 is configured to output the digital object corresponding to the selected handwritten object (handwritten character string, handwritten table, handwritten figure, etc.) to other application programs (export). The processing of generating the digital object corresponding to the selected handwritten object is executed using the character recognition, figure recognition and table recognition as well as in the case of the copy as document integration application data.

It should be noted that timing of executing the processing of generating the digital object corresponding to the selected handwritten object is not limited to the above timing. Only the generating processing may be executed by an instruction from the user independently of other processing.

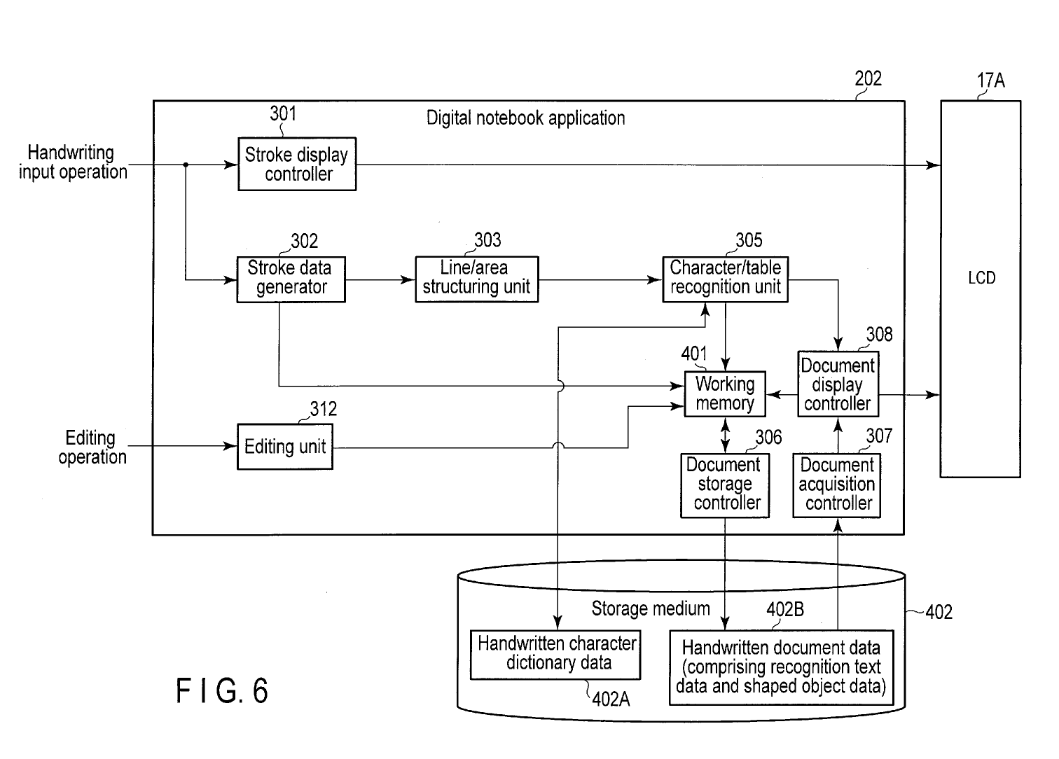

FIG. 6 shows an example of a function configuration of the digital notebook application program 202 executed by the tablet 10. The digital notebook application program 202 includes a function of recognizing a character and a table in stroke data (or handwritten document data) input by an operation with the touch screen display 17 or handwritten document data read from a storage medium 402.

The digital notebook application program 202 includes, for example, a stroke display controller 301, a stroke data generator 302, a line/area structuring unit 303, a character/table recognition unit 305, a document storage controller 306, a document acquisition controller 307, a document display controller 308 and an editing unit 312.

The touch screen display 17 is configured to detect generation of an event such as touch, move (slide) and release. Touch is an event indicating that an external object contacts the screen. Move (slide) is an event indicating that a contact position moves while the external object is in contact with the screen. Release is an event indicating that the external object is released from the screen. The stroke display controller 301 and the stroke data generator 302 receive the event of touch, move (slide) or release generated by the handwriting input operation on the touch screen display 17 to detect the handwriting input operation. The touch event includes coordinates of a contact position. The move (slide) event includes coordinates of a contact position of a destination. The release event includes coordinates of a position at which a contact position is released from the screen. Thus, the stroke display controller 301 and the stroke data generator 302 can receive a coordinate string corresponding to a locus of motion of a contact position from the touch screen display 17.

The stroke display controller 301 displays at least one stroke written by hand on the screen of the touch screen display 17. The stroke display controller 301 receives a coordinate string from the touch screen display 17, and displays a locus of each stroke handwritten by the handwriting input operation with the stylus 100, etc., on the screen of the LCD 17A in the touch screen display 17 based on the coordinate string. The locus of the stylus 100 while the stylus 100 is in contact with the screen, that is, a stroke is drawn on the screen of the LCD 17A by the stroke display controller 301.

The stroke data generator 302 receives the coordinate string output from the touch screen display 17, and generates stroke data including a structure as described in detail in FIG. 4 based on the coordinate string. In this case, coordinates corresponding to each point of a stroke and timestamp data may be temporarily stored in a working memory 401. The stroke data generator 302 outputs the generated stroke data to the line/area structuring unit 303. The line/area structuring unit 303 may read stroke data corresponding to a displayed handwritten document from the working memory 401 or the storage medium 402 upon request of character recognition, table recognition, and figure recognition of the handwritten document.

The line/area structuring unit 303 analyzes a structure of stroke data corresponding to a handwritten document of one page, divides the page into a plurality of lines, and generates a stroke data item of one line as shown in, for example, FIG. 3. The line/area structuring unit 303 determines that strokes adjacent in time-series order are included in one line when, for example, the strokes are within the range of a threshold value. Next, the line/area structuring unit 303 subdivides stroke data of each line, and determines whether a group of subdivided stroke data includes one or more ruled line strokes or not. In FIG. 4, the data is subdivided into stroke data groups SD1 and SD2, stroke data groups SD3 and SD4, stroke data item SD5, stroke data groups SD6 and SD7, etc. The stroke data group including one or more ruled line strokes is regarded as a table area candidate, and that without one or more ruled line strokes is regarded as a character area candidate.

The stroke display controller 301 and the stroke data generator 302 may receive a coordinate string corresponding to a position on a screen of a display and a locus of motion of the position from various pointing devices such as a mouse, a stylus-type mouse and a touchpad. In this case, the stroke display controller 301 displays at least one stroke written by hand on the screen using such a pointing device. Further, the stroke data generator 302 receives a coordinate string output from the pointing device, and generates stroke data including a structure as described in detail in FIG. 4 based on the coordinate string.

The document storage controller 306 stores handwritten document data (stroke data) 402B in the storage medium 402. The document storage controller 306 may periodically automatically store the handwritten document data being edited in the storage medium 402. When the digital notebook application program 202 is stopped/completed, the document storage controller 306 may automatically store the handwritten document data being edited in the storage medium 402. The document acquisition controller 307 acquires a handwritten document to be browsed or edited from the storage medium 402.

A stroke data group into which a handwritten document is subdivided by the line/area structuring unit 303 and a determination result of an area candidate of the stroke data group are supplied to the character/table recognition unit 305. The character/table recognition unit 305 finally determines a character area or a table area for each stroke data group with reference to the determination result, and performs character recognition or table recognition processing in accordance with the final determination result. In the character recognition processing, text data including a character code as a digital character object corresponding to the stroke data group is determined. The character recognition is performed by comparing the stroke data group with stroke data in handwritten character dictionary data 402A in the storage medium 402. In the table recognition processing, stroke data corresponding to a straight line according to a handwritten ruled line in a table is obtained, text data corresponding to a handwritten character in the table is obtained, and a digital table object handled in a spreadsheet application is obtained from them. All or part of processing of the line/area structuring unit 303 and the character/table recognition unit 305 is not necessarily carried out by the tablet 10. It may be executed by the server 2.

A digital object which is an output of the character/table recognition unit 305 is supplied to the document display controller 308 and the working memory 401. The document storage controller 306 writes handwritten document data in the working memory 401 (with text data of character recognition result and shaped digital table object data) in the storage medium 402. The document acquisition controller 307 reads the handwritten document data 402B from the storage medium 402, and supplies it to the display controller 308.

The digital notebook application program 202 also includes the editing unit 312, and performs editing processing of copy, cut, paste, etc., on the handwritten document data in the working memory 401 in accordance with an editing operation.

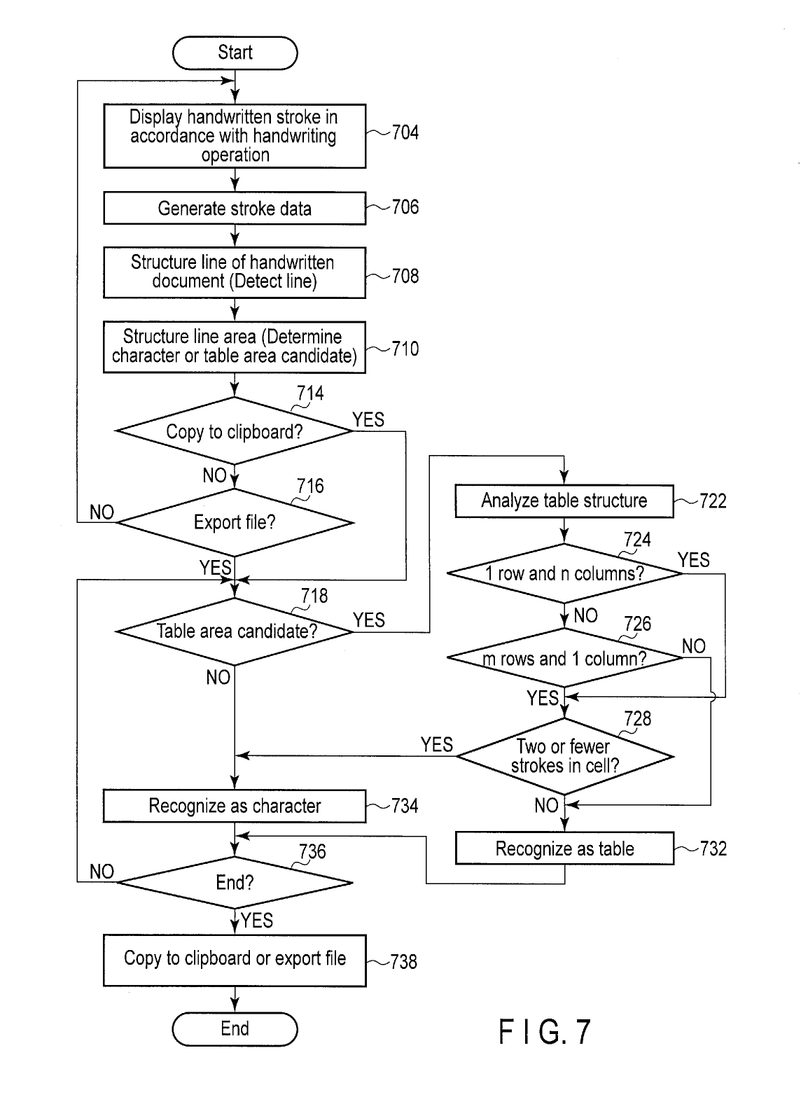

An example of processing of the digital notebook application program 202 will be described with reference to the flowchart of FIG. 7. In block 704, the stroke display controller 301 displays a locus of motion (stroke) of the stylus 100, etc., by the handwriting input operation on the LCD 17A. In block 706, the stroke data generator 302 generates stroke data as in FIG. 4 based on a coordinate string corresponding to a locus by the handwriting input operation, and temporarily stores the stroke data in the working memory 401. In block 708, the line/area structuring unit 303 detects a line in a handwritten document using stroke data corresponding to a stroke written by hand. The line/area structuring unit 303 determines that strokes adjacent in time-series order are included in one line when, for example, the strokes are within the range of a threshold value. Next, in block 710, the line/area structuring unit 303 subdivides stroke data of each line into some stroke data groups, and determines whether the stroke data groups are character area candidates or table area candidates.

In blocks 714 and 716, it is determined whether a predetermined operation as a trigger of character recognition or table recognition is performed or not. In block 714, it is determined whether an instruction to copy a digital object to a clipboard as document integration application data is given or not. If the result of the determination is No, it is determined in block 716 whether an instruction to export the digital object to another application program is given or not. If the result of the determination is No, the processing returns to block 704, and a stroke is continued to be written by hand. If the result of the determination is Yes in block 714 or 716, it is determined for each stroke data group in block 718 whether the stroke data group is the table area candidate or not. It should be noted that the predetermined operation as a trigger of character recognition and table recognition is not limited to the above two. Other operations requiring the character recognition and table recognition may be performed, or a character recognition instruction and a table recognition instruction may be separately given.

If it is determined in block 718 that a stroke data group is not the table area candidate, that is, the stroke data group is the character area candidate, the character/table recognition unit 305 performs character recognition of the stroke data group using the handwritten character dictionary data 402A and obtains text data in block 734. The text data is accompanied by the stroke data.

If it is determined in block 718 that a stroke data group is the table area candidate, a table structure is analyzed in block 722. Specifically, one cell defined by vertical and horizontal ruled lines or a block of a plurality of cells are detected, and the number of rows and that of columns of cells included in the table are determined. In the present embodiment, a stroke data group can be an area other than a table, for example, the character area, not the table area, depending on the number of rows and that of columns, even if it is determined to be the table area candidate by the line/area structuring unit 303. The cells of a table corresponding to a stroke group will be expressed by m rows and n columns (m and n are integers of 1 or greater). If the number of rows, m is greater than or equal to a first value, and the number of columns, n is greater than or equal to a second value, the stroke group is recognized as an object of the table. If the number of rows, m is less than the first value, and the number of columns, n is less than the second value, the stroke group is recognized as an object other than the table. At least one of the first and second values is determined in accordance with a stroke included in an area of a plurality of cells. For example, if a stroke is present in the area of the plurality of cells, a third value less than the first value is used instead of the first value, or a fourth value less than the second value is used instead of the second value.

Furthermore, the plurality of strokes are recognized to be the object other than the table, when the number of rows, m is less than the first value and the number of columns, n is less than the second value, or when the number of rows, m is less than the second value and the number of columns, n is less than the first value.

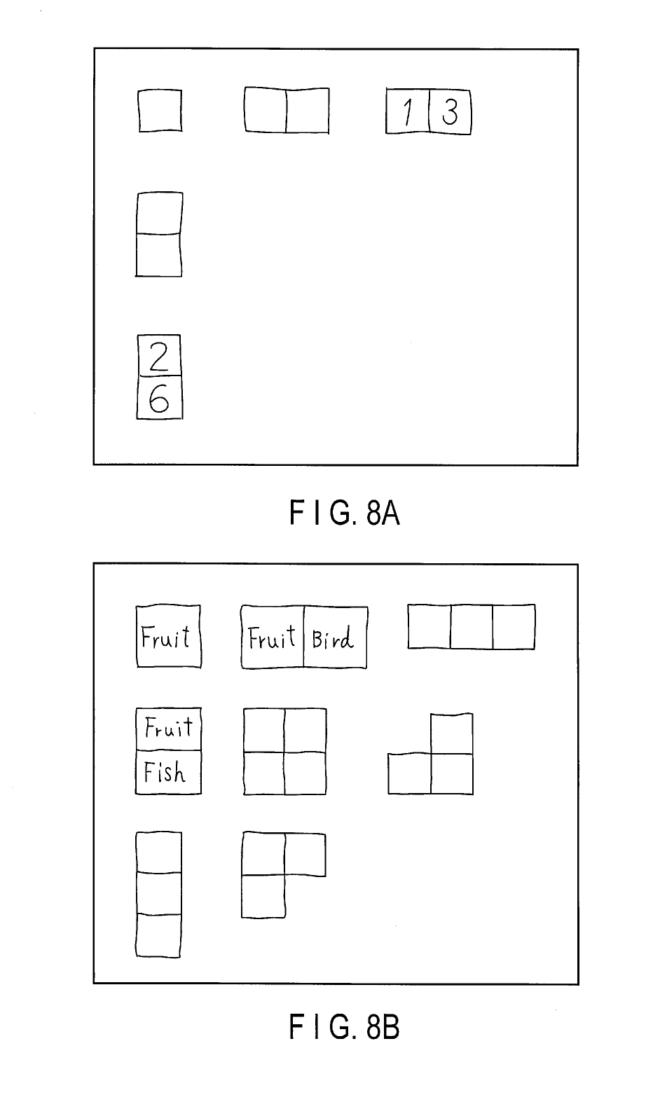

FIG. 8A shows an example of the stroke data group determined to be the character area. FIG. 8B shows an example of the stroke data group determined to be the table area. As shown in FIG. 8A, a single cell including two or fewer strokes, a cell matrix of 1 row and 2 columns including two or fewer strokes, and a cell matrix of 2 rows and 1 column including two or fewer strokes are determined to be the character area. As shown in FIG. 8B, a single cell or all cell matrices including at least three strokes, and a cell matrix of at least 2 rows and at least 2 columns, regardless of the number of strokes in cells, are determined to be the table area. As shown in FIG. 8B, the cell matrix of 2 rows and 2 columns also includes three cells including 2 rows and 2 columns. Although an area other than the table area is determined to be the character area, a figure area is also present. Thus, the area other than the table area is not necessarily determined to be the character area. Further, in this case, an input stroke is directly output without shaping. If the format of data to be output is a presentation format, the data is output as a free curve.

In block 724, to perform the above determination, it is determined whether a cell matrix included in a table is 1 row and n columns (n is 1 or 2) or not. If the answer is No, it is determined in block 726 whether the cell matrix included in the table is m rows and 1 column (m is 1 or 2) or not. If the answer is No in block 726, the cell matrix is 1 row and at least 3 columns, at least 3 rows and 1 column, and at least 2 rows and at least 2 columns; thus, it is determined in block 732 that the area is the table area, and the table recognition processing is performed. In the table recognition processing, a handwritten ruled line stroke is regarded as a straight ruled line object, and a character in a cell is regarded as text data. A digital table object is generated by both of them, and is accompanied by stroke data.

If the result of the determination in block 723 or 726 is Yes, it is determined in block 728 whether two or fewer strokes are present in the cell matrix or not. If two or fewer strokes are present, the area is determined to be the character area, and the character/table recognition unit 305 performs character recognition of the stroke data group using the handwritten character dictionary data 402A to obtain text data in block 734. The text data is accompanied by the stroke data.

If two or fewer strokes are not in the cell matrix in block 728, that is, if at least three strokes are present, it is determined in block 732 that the area is the table area, and the table recognition processing is performed by the character/table recognition unit 305. In the table recognition processing, a handwritten ruled line stroke is regarded as a straight ruled line object, and a character in a cell is regarded as text data. The digital table object is generated by both of them, and is accompanied by the stroke data. It should be noted that the determination in block 728 is not essential. The table area and the area other than the table area may be determined only based on the numbers of rows and columns of cells.

When the character recognition processing in block 734 or the table recognition processing in block 732 is completed, it is determined in block 736 whether the recognition processing is completed or not, that is, whether an unconfirmed stroke data group remains or not. If the result of the determination is No, the processing returns to block 718, and the processing of the remaining stroke data group continues. If the recognition processing is completed, text data or a digital table object accompanied by the stroke data is copied (stored) to a clipboard, or output to another application program (export).

As described above, in the present embodiment, when the digital object is generated from the stroke data, a table area candidate including a ruled line stroke is tentatively determined, and the table area candidate is finally determined as the table area or the area other than the table area in accordance with the number of rows or columns of the cell matrix. This prevents the table area and the area other than the table area from being erroneously recognized. For example, the cell matrix of 1 row and n columns or m rows and 1 column (here, m=1 or 2, n=1 or 2) is considered to be the area other than the table area. Further, if the total number of strokes included in cells is a predetermined number or greater, such a cell matrix is considered to be the table area, even if it is the cell matrix of 1 row and n columns or m rows and 1 column. Thus, when the digital object is displayed, a character recognition and a table recognition results intended by the user are displayed, and the quality of the digital object is improved.

The above description is based on stroke data, and relates to a tablet including a touch screen display on which handwriting input is possible; however, the description is not necessarily directed to such a tablet. It can also be applied to a device configured to recognize a bitmap image obtained by scanning paper on which a document has been written by hand. In this case, the total number of strokes in cells in block 728 of FIG. 7 may be replaced with a document amount in the cells, for example, an area of a dot. Further, a start trigger of recognition is not limited to copy or export, but may be based on an instruction dedicated to recognition. If, for example, a handwritten document is to be shaped and displayed, the processing of FIG. 7 is performed by pressing a shape button after handwriting. When the recognition result is obtained, the digital object may be displayed instead of the handwritten document. Furthermore, although the number of strokes in cells is referred to in addition to the number of cell matrices, determination may be performed only based on the number of cell matrices without referring to the number of strokes in cells.

It should be noted that each of the various functions described in the present embodiment may also be realized by a processing circuit. The processing circuit also includes, for example, a programmed processor such as a central processing unit (CPU). The processor executes each of the described functions by executing a computer program stored in a memory (group of instructions). The processor may be a microprocessor including an electric circuit. The processing circuit includes, for example, a digital signal processor (DSP), an application-specific integrated circuit (ASIC), a microcontroller, a controller and other electric circuit components. Each of the components other than the CPU described in the present embodiment may also be realized by the processing circuit.

Further, since various types of processing of the present embodiment can be realized by a computer program, an advantage similar to that in the present embodiment can be easily realized merely by installing the computer program in a computer through a computer-readable storage medium storing the computer program and by executing it.

Further, the case where a tablet is used is described with examples in the present embodiment; however, each function of the present embodiment can be applied also to a normal desktop computer. In this case, for example, the tablet which is an input device for handwriting input may be connected to the desktop computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic apparatus comprising:
circuitry configured to:
receive data relating to a plurality of strokes comprising a plurality of vertical lines and a plurality of horizontal lines, wherein a plurality of cells substantially surrounded by the plurality of vertical lines and the plurality of horizontal lines are formed, and a table is formed by the plurality of cells, the table comprising m rows and n columns, wherein m and n are integers greater than or equal to one;
recognize the plurality of strokes as a table object when m is greater than or equal to a first value and n is greater than or equal to a second value; and
recognize the plurality of strokes as an object other than the table object when m is less than the first value and n is less than the second value.

2. The electronic apparatus of claim 1, wherein
the circuitry is further configured to recognize the plurality of strokes as the object other than the table object when the table formed by the plurality of cells comprises 1 row and n columns or m rows and 1 column, wherein n and m are 1 or 2.

3. The electronic apparatus of claim 1, wherein
at least one of the first and second values is determined based on the number of strokes included in an area of the plurality of cells.

4. The electronic apparatus of claim 1, wherein
the circuitry is further configured to perform processing using a third value replacing the first value and/or processing using a fourth value replacing the second value when a stroke is present in the plurality of cells, the third value less than the first value and the fourth value less than the second value.

5. The electronic apparatus of claim 1, wherein
the data relating to the plurality of strokes comprises image data.

6. The electronic apparatus of claim 1, wherein
the circuitry is further configured to recognize the plurality of strokes as the object other than the table object, when m is less than the first value and n is less than the second value, or when m is less than the second value and n is less than the first value.

7. The electronic apparatus of claim 1, wherein
the circuitry is further configured to recognize the plurality of strokes during at least one of copying, exporting, and/or storing the plurality of strokes.

8. A method comprising:
receiving data relating to a plurality of strokes comprising a plurality of vertical lines and a plurality of horizontal lines, wherein a plurality of cells substantially surrounded by the plurality of vertical lines and the plurality of horizontal lines are formed, and a table is formed by the plurality of cells, the table comprising m rows and n columns wherein m and n are integers greater than one or equal to one;
recognizing the plurality of strokes as a table object when m is greater than or equal to a first value and n is greater than or equal to a second value; and
recognizing the plurality of strokes as an object other than the table object when m is less than the first value and n is less than the second value.

9. The method of claim 8, further comprising:
recognizing the plurality of strokes as the object other than the table object when the table formed by the plurality of cells comprises 1 row and n columns or m rows and 1 column wherein n and m are 1 or 2.

10. The method of claim 8, wherein
at least one of the first and second values is determined based on the number of strokes included in an area of the plurality of cells.

11. The method of claim 8, further comprising:
performing processing using a third value replacing the first value and/or processing using a fourth value replacing the second value when a stroke is present in the plurality of cells, the third value less than a first value and the fourth value less than the second value.

12. The method of claim 8, wherein
the data relating to the plurality of strokes comprises image data.

13. The method of claim 8, further comprising:
recognizing the plurality of strokes as the object other than the table object, when m is less than the first value and n is less than the second value, or when m is less than the second value and n is less than the first value.

14. The method of claim 8, further comprising:
recognizing the plurality of strokes during at least one of copying, exporting, and/or storing the plurality of strokes.

15. A non-transitory computer readable medium having a plurality of executable instructions configured to cause one or more computers to perform processing comprising at least:
receiving data relating to a plurality of strokes comprising a plurality of vertical lines and a plurality of horizontal lines, wherein a plurality of cells substantially surrounded by the plurality of vertical lines and the plurality of horizontal lines are formed, and a table is formed by the plurality of cells, the table comprising m rows and n columns wherein m and n are integers greater than one or equal to one;
recognizing the plurality of strokes as an table object when m is greater than or equal to a first value and n is greater than or equal to a second value; and
recognizing the plurality of strokes as an object other than the table object when m is less than the first value and n is less than the second value.

16. The non-transitory computer readable medium of claim 15, wherein the processing further comprises:
recognizing the plurality of strokes as the object other than the table object when the table formed by the plurality of cells comprises 1 row and n columns or m rows and 1 column wherein n and m are 1 or 2.

17. The non-transitory computer readable medium of claim 15, wherein
at least one of the first and second values is determined based on the number of strokes included in an area of the plurality of cells.

18. The non-transitory computer readable medium of claim 15, wherein the processing further comprises:
performing processing using a third value replacing the first value and/or processing using a fourth value replacing the second value, when a stroke is present in the plurality of cells, the third value less than the first value and the fourth value less than the second value.

19. The non-transitory computer readable medium of claim 15, wherein
the data relating to the plurality of strokes comprises image data.

20. The non-transitory computer readable medium of claim 15, wherein the processing further comprises:
recognizing the plurality of strokes as the object other than the table object, when m is less than the first value and n is less than the second value, or when m is less than the second value and n is less than the first value.
